(19) United States
(12) Patent Application Publication
(10) Pub. No.: US 2012/0325068 A1
(43) Pub. Date: Dec. 27, 2012

(54) CUTTING APPARATUS FOR ADHESIVE TAPE ROLLS

(75) Inventors: Sadaji SUTOU, Ibaraki-shi (JP); Futoshi MATSUE, Ibaraki-shi (JP); Akira OKANO, Ibaraki-shi (JP)

(73) Assignee: NITTO DENKO CORPORATION, Ibaraki-shi, Osaka (JP)

(21) Appl. No.: 13/528,054

(22) Filed: Jun. 20, 2012

(30) Foreign Application Priority Data
Jun. 24, 2011 (JP) 2011-140278

(51) Int. Cl. B26D 1/18

(52) U.S. Cl. 83/471.2

(57) ABSTRACT

To restrain shifting of a circular blade, and reduce a cutting-in angle of the circular blade with respect to the tape roll main body, both ends of a rotatable blade shaft 38 is supported by a pair of shaft bearings 39a and 39b of shaft supporting members 37 of a tool post 20. The circular blade 21 is mounted to the blade shaft 38, between the shaft bearings 39a and 39b. This prevents the blade shaft 38 from being shifted or bent, restrains shifting of the circular blade 21, and reduce the cutting-in angle of the circular blade 21 with respect to the tape roll main body.

### CROSS REFERENCE TO RELATED APPLICATION

The present application claims priority from Japanese Patent Application No. 2011-140278, which was filed on Jun. 24, 2011, the disclosure of which is herein incorporated by reference in its entirety.

### BACKGROUND OF THE INVENTION

1. Technical Field

The present invention relates to a cutting apparatus for an adhesive tape roll, which cuts in rounds an adhesive tape roll.

2. Background Art

In many cases, wide adhesive tape with an adhesive layer formed on its one side or both sides is rolled on a core such as a paper tube so as to form an adhesive tape roll. This adhesive tape roll is then cut in rounds at a predetermined width as the end product.

To cut in rounds such an adhesive tape roll, the adhesive tape roll is rotatably attached to a tape roll supporting device. Then a circular blade rotatably attached to a tool post is forwarded perpendicularly to the axis of the adhesive tape roll. Then, while driving (rotating) at least one of the adhesive tape roll and the circular blade, the circular blade is pressed against a predetermined cutting position on the body of the adhesive tape roll (e.g., see Japanese Unexamined Patent Publications No. 162097/1993 (Tokukaihei 5-162097; hereinafter Patent document 1) and No. 155370/1994 (Tokukaihei 6-155370; hereinafter Patent document 2)).

In cases of driving (rotating) the adhesive tape roll, the circular blade pressed against is rotated by the rotation of the adhesive tape roll, thus cutting in rounds the adhesive tape roll. In cases of driving (rotating) the circular blade, the adhesive tape roll is rotated by the rotation of the circular blade, thus cutting in rounds the adhesive tape roll. In cases of driving (rotating) the adhesive tape roll, the circular blade is fixed in some cases. Note that, as the tape roll supporting device, there is a type which inserts a rotatable shaft member into the core of the adhesive tape roll, and there is a type having a pair of rotatable chuck members capable of sandwiching the core from the both ends of the core.

Traditionally, in such a cutting apparatus of the adhesive tape roll, a rotatable blade shaft to which the circular blade is mounted is cantilevered to the tool post. From the free end of this cantilevered blade shaft, the circular blade having a center hole is mounted. The mounted circular blade is then fixed to the blade shaft by sandwiching the same with a holder on both sides.

Note that Patent document 2 describes a structure in which the edge of the circular blade is tilted towards the tape roll main body when pressing the edge against the cutting portion. This is to prevent a problem that, when cutting in rounds the adhesive tape roll, the circular blade is tilted towards a tape roll to be cut out, resulting in a convex cut-surface on the tape roll main body and a concave cut-surface on a side of the tape roll having been cut out.

### SUMMARY OF THE INVENTION

In the adhesive tape roll cutting apparatus having the cantilevered blade shaft for the circular blade, the circular blade is easily attached or detached from the free end of the blade shaft; however, when the circular blade is pressed against the body of the adhesive tape roll, the cantilevered blade shaft is deviated. Due to this, the circular blade for cutting the adhesive tape roll is easily deviated. This shifting of the circular blade causes the convex and concave cut-surfaces, and straight cut-surfaces are not obtained, which consequently leads to defectives. Further, the convex and concave cut-surfaces cause the adhesive agent on the adhesive tape roll to easily exude. This may result in adhesion of the adhesive agent on the circular blade, which will lead to unclean cut-surfaces and an increased in the cutting resistance.

Further, when the blade shaft is bent, the circular blade mounted on the cantilevered blade shaft is easily deviated in a direction of cutting out a tape roll. This necessitates an increase in the angle of tilting the circular blade (hereinafter, cutting-in angle) towards the tape roll main body. Increasing this cutting-in angle of the circular blade causes an increase in the area of the adhesive layers of the adhesive tape roll contacting the circular blade. This causes adhesion of the adhesive agent on the circular blade, thus increasing the cutting resistance.

In view of the above problems, an object of the present invention is to restrain the deviation of the circular blade, while reducing a cutting-in angle of the circular blade with respect to the tape roll main body.

An aspect of the present invention, to achieve the foregoing object, is a cutting apparatus for an adhesive tape roll, essentially including: a tape roll supporting device to which the adhesive tape roll is rotatably attached, the adhesive tape roll formed by rolling, on a core, wide adhesive tape having an adhesive layer formed on its one side or both sides; and a tool post to which a circular blade is mounted by inserting a rotatable blade shaft into a center hole formed on the circular blade, wherein at least one of the adhesive tape roll and the circular blade is driven to rotate and the tool post having the circular blade mounted thereto is forwarded towards the adhesive tape roll perpendicularly to the axis of the adhesive tape roll, thereby pressing the circular blade to a predetermined cutting position on the body of the adhesive tape roll to cut in rounds the adhesive tape roll, and wherein the rotatable blade shaft has both ends supported by a pair of shaft bearings of the tool post, and a circular blade is mounted to the blade shaft, between the pair of shaft bearings supporting the both ends of the blade shaft.

That is, the both ends of the rotatable blade shaft supported by a pair of shaft bearings of the tool post, and a circular blade is mounted to the blade shaft between the pair of shaft bearings. This way, shifting or bending of the blade shaft is prevented, and shifting of the circular blade is restrained. At the same time, reduction of the cutting-in angle of the circular blade with respect to the tape roll main body is made possible.

The circular blade is mounted to the tool post to be forwarded towards the adhesive tape roll, along a center line of the tool post. This prevents deviation in the direction in which the tool post is forwarded. As the result, shifting of the circular blade is more effectively restrained.

A structure for attaching the circular blade to the blade shaft between the pair of shaft bearings is such that at least the blade shaft is pulled out from one of the shaft bearings, the circular blade is set between the pair of shaft bearings while the blade shaft is pulled out from that one of the shaft bearings, and then the blade shaft having been pulled out is inserted into a center hole of the circular blade and into the shaft bearing again. This allows the circular blade to be easily detached or attached.

In a cutting apparatus of the present invention for an adhesive tape roll, both ends of a rotatable blade shaft is supported by a pair of shaft bearings on the tool post. Between these shaft bearings, a circular blade is attached to the blade shaft. This structure restrains deviation of the circular blade, and reduces a cutting-in angle of the circular blade with respect to the tape roll main body. Thus, a suitable straight cut-surface is obtainable.

### BRIEF DESCRIPTION OF THE DRAWINGS

FIG. 1 is a front view showing an embodiment of a cutting apparatus for an adhesive tape roll.

FIG. 2 is a side view of FIG. 1.

FIG. 3 is a broken-away front view showing a tool post shown in FIG. 1.

FIG. 4 is a broken-away side view of FIG. 3.

FIG. 5 is a plan layout diagram of the upper slide table, the rotating plate, and the middle slide table shown in FIG. 3.

FIG. 6 is a front cross-sectional view showing a process of attaching the circular blade to the blade shaft shown in FIG. 3.

### DESCRIPTION OF THE PREFERRED EMBODIMENTS

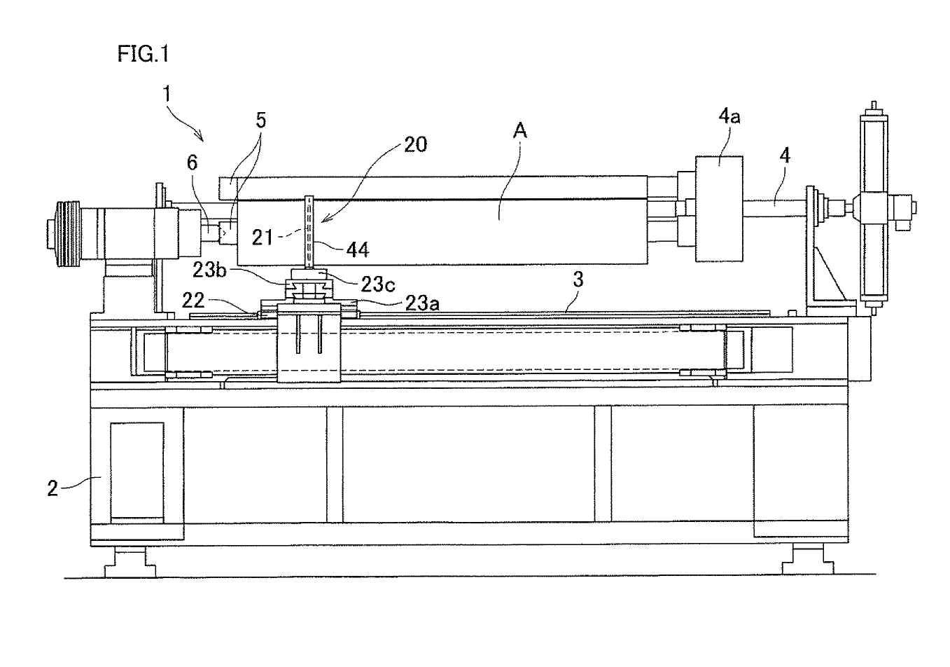

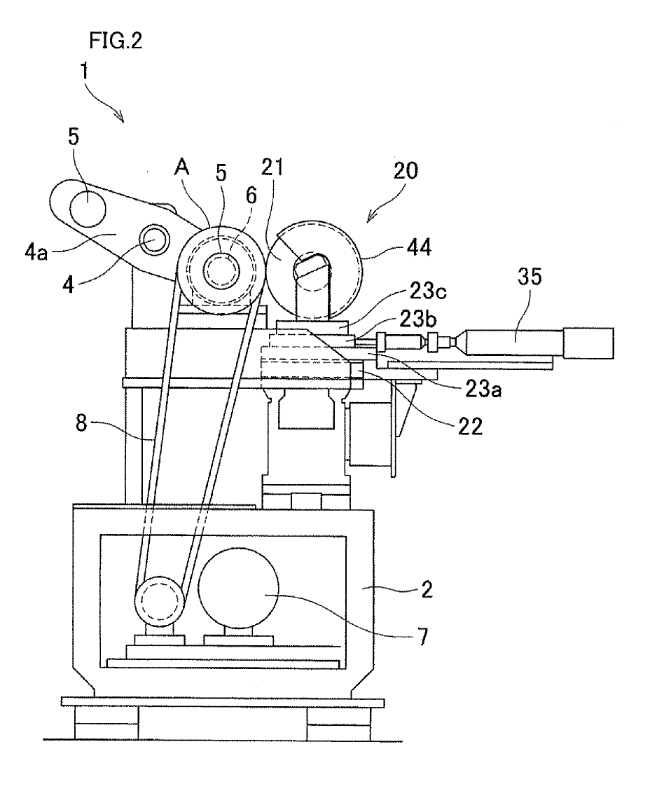

The following describes an embodiment of the present invention, with reference to attached drawings. As shown in FIG. 1 and FIG. 2, the adhesive tape roll cutting apparatus includes: a tape roll supporting device 1 to which an adhesive tape roll A is rotatably attached, the adhesive tape roll A being formed by rolling on a core wide adhesive tape having an adhesive layer on its one side or the both sides; and a tool post 20 to which a circular blade 21 for cutting in rounds the adhesive tape roll A is rotatably attached. The tool post 20 is attached to the base 2 of the tape roll supporting device 1, and is structured so as to be moved parallel to the axis of the adhesive tape roll A, guided by a guide rail 3.

The tape roll supporting device 1 has two shaft members 5 and a chuck member 6. The shaft members 5 are cantilevered to not-shown shaft bearings at the both ends of a pivot arm 4a which is turned about the pivot shaft 4 between a front position and a rear position. The chuck member 6 moves parallel to the axes of the shaft members 5 and engages with one of the shaft members 5 which is in the front position. The chuck member 6 is driven (rotated) by a motor 7 and a belt 8. The adhesive tape roll A is attached to one of the shaft members 5 in the rear position, and is turned to the front position along with that one of the shaft members 5. Then, the chuck member 6 forwards and engages with the free end of that one of the shaft members 5. Rotating the chuck member 6 rotates the shaft member 5 and the adhesive tape roll A, and thus, the adhesive tape roll A is cut in rounds as described later. Tape rolls cut out of the adhesive tape roll A are then taken out from the shaft member 5 in the rear position.

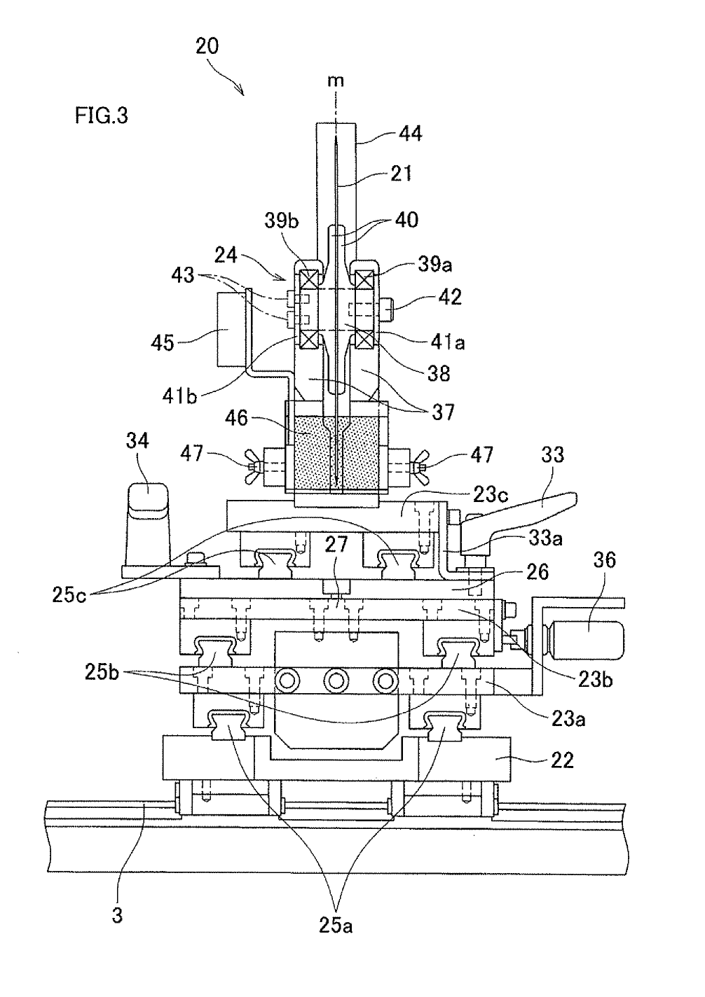

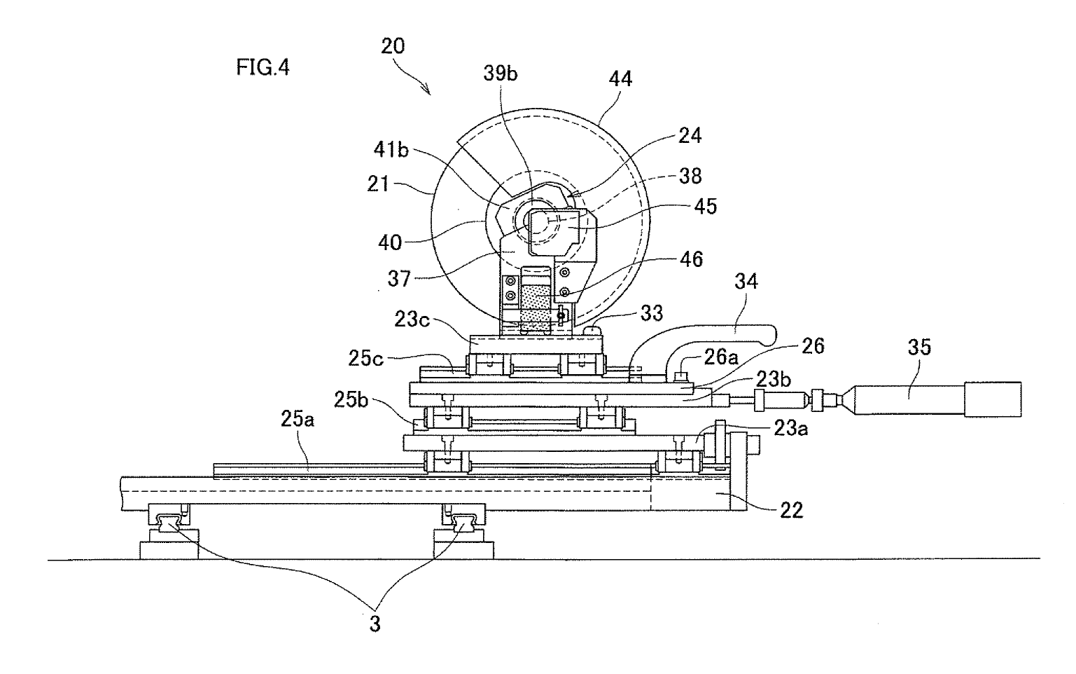

As shown in FIG. 3 and FIG. 4, the tool post 20 is disposed on a base table 22 which is guided by the guide rail 3 of the base 2. The tool post 20 includes a lower slide table 23a, a middle slide table 23b, and an upper slide table 23c, which are stacked to form three stages. The upper slide table 23c at the top has thereon a blade mounting part 24 to which the circular blade 21 is mounted. The slide tables 23a, 23b, and 23c have, under their bottom surface, pairs of parallel guide rails 25a, 25b, 25c, respectively. These pairs of guide rails 25a, 25b, 25c guide the movement of the slide tables 23a, 23b, and 23c in a back/forth direction which is perpendicular to the axis of the adhesive tape roll A in the front position. The rails forming each of the pairs of guide rails 25a, 25b, 25c are arranged symmetrical with respect to the center line m of the tool post 20 which moves the circular blade 21.

The upper slide table 23c is stacked on the middle slide table 23b with a rotating plate 26 therebetween. The pair of guide rails 25c on which the upper slide table 23c is guided and slid are attached to the top surface of the rotating plate 26. The pair of guide rails 25a for the lower slide table 23a, and the pair of guide rails 25b for the middle slide table 23b are directly attached to the base table 22 and the lower slide table 23a, respectively.

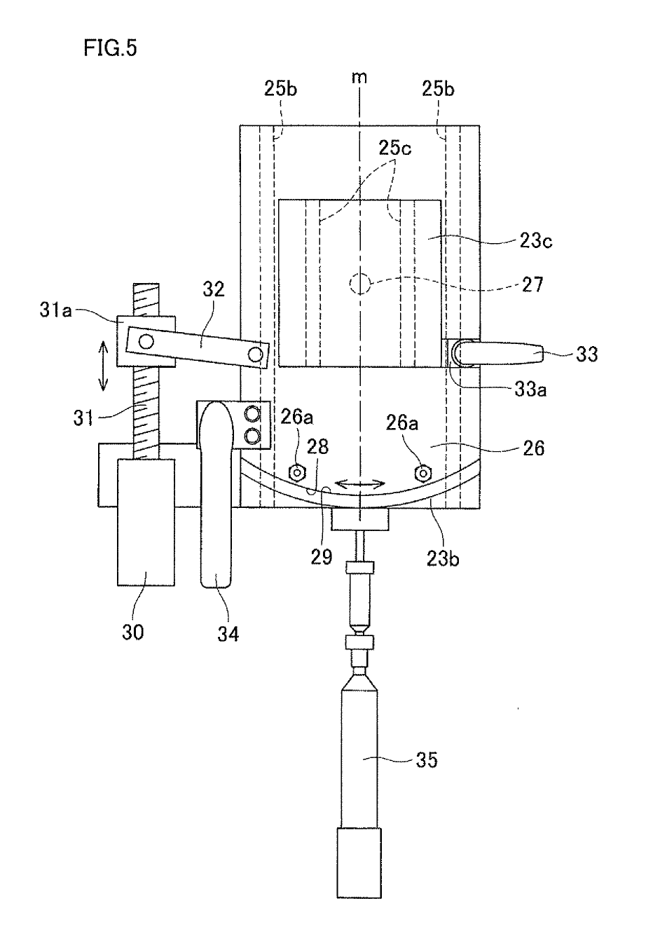

As shown in FIG. 5, the rotating plate 26 is horizontally rotatable about the turning shaft 27 which is provided to the middle slide table 23b along the center line m of the tool post 20. The rear end surface of the rotating plate 26 forms a convex arc 28 about the turning shaft 27. At the rear end portion of the middle slide table 23b below the rotating plate 26 is provided a concave arc 29 which guides the convex arc 28. Further, on a side of the middle slide table 23b is attached a ball screw 31 disposed along the back/forth direction, which is driven by a servo motor 30. The ball screw 31 has a nut 31a which makes a linear movement with rotation of the ball screw 31. This nut 31a is connected to the rotating plate 26 via a turn lever 32. Thus, driving the ball screw causes the rotating plate 26 connected via the turn lever 32 to horizontally rotate, guided by the convex arc 28 and the concave arc 29, thus enabling adjustment of the cutting-in angle of the circular blade 21 with respect to the adhesive tape roll A. The rotational position of the rotating plate 26 on the middle slide table 23b is fixed by the bolt 26a, after adjustment of the cutting-in angle.

As shown in FIG. 3 and FIG. 4, to the rotating plate 26 are attached a clamp lever 33 which fixes the upper slide table 23c via the joint member 33a on the rotating plate 26, and a grip 34 for moving the middle slide table 23b in the back/forth direction, along with the rotating plate 26. Further, on the rear side of the middle slide table 23b is jointed a cylinder 35 for automatically forwarding the middle slide table 23b along with the rotating plate 26 and the upper slide table 23c, when cutting the adhesive tape roll A.

When cutting the adhesive tape roll A having an even outer diameter, the lower slide table 23a is fixed on the base table 22, and positioned a suitable distance away from the body of the adhesive tape roll A relative to the back/forth direction, according to the outer diameter thereof. To the lower slide table 23a is attached a limit switch 36 which regulates the foremost position of the middle slide table 23b so as to prevent the circular blade 21 from excessively forwarding, at the time of cutting the adhesive tape roll A.

The blade mounting part 24 has a pair of shaft supporting members 37 provided upright on the upper slide table 23c. The shaft supporting members 37 have a pair of rolling shaft bearings 39a and 39b which hold the both sides of the blade shaft 38 to which the circular blade 21 is mounted. The circular blade 21 is mounted to the blade shaft 38, between the pair of shaft bearings 39a and 39b, and is sandwiched by the holders 40 so as to be fixed along the center line m of the tool post 20.

Thus, as hereinbelow described, when the circular blade 21 is pressed against the adhesive tape roll A during a cutting operation, the blade shaft 38 will not be deviated or bent. This prevents deviation of the circular blade 21, and reduces the cutting-in angle of the circular blade 21 with respect to the tape roll main body.

The blade shaft 38 is kept from coming off by press plates 41a and 41b attached to the outer surfaces of the shaft supporting members 37, respectively. To one end of the blade shaft 38 is attached a grip bolt 42 for pulling out the blade shaft 38. The press plate 41b on the opposite side to the side of the blade shaft 38 having the grip bolt 42 is structured so that screws 43 for locking the rotation of the blade shaft 38 is attachable. This allows the rotation of the circular blade 21 to be fixed at a time of cutting a special adhesive tape roll. When cutting an ordinary adhesive tape roll A, the circular blade 21 to be pressed against the adhesive tape roll A is rotated by the rotation of the adhesive tape roll A.

Further, the blade mounting part 24 is provided with: a blade cover 44 which covers the circumference of the circular blade 21 except for the part for cutting; a rotation sensor 45 for detecting the rotation of the circular blade 21; and a felt 46 for wiping off the adhesive agent of the adhesive tape roll A adhered to the circular blade 21. The felt 46 is pressed against the circular blade 21 by adjusting fastening of a thumbscrew 47.

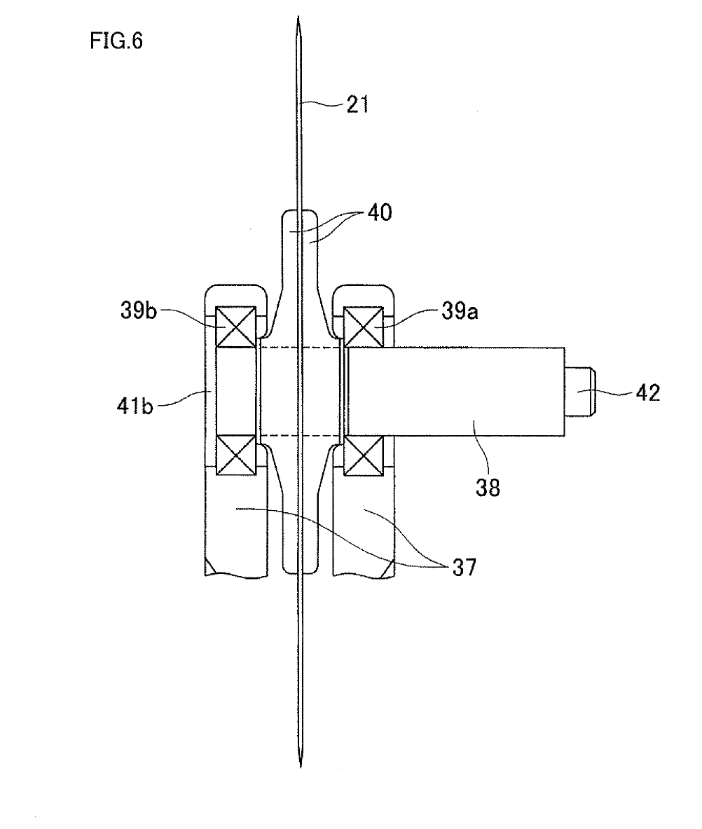

FIG. 6 is a diagram for explaining a process of mounting the circular blade 21 to the blade shaft 38. Starting from a state in which the blade cover 42 and one of the press plates 41a are detached and the blade shaft 38 is pulled out from the shaft bearings 39b, the circular blade 21 is sandwiched by the pair of holders 40 and set between the pair of shaft bearings 39a and 39b. After that, the blade shaft 38 is inserted into the center holes of the circular blade 21 and the holders 40, and then inserted into the shaft bearing 39b. Then, the blade cover 42 and the press plate 41a is attached. Thus, the circular blade 21 is mounted to the blade shaft 38 as shown in FIG. 3.

The following describes the steps of cutting in rounds the adhesive tape roll A which is rotated with the shaft member 5 at the front position. First, based on the outer diameter of the adhesive tape roll A, the position of the lower slide table 23a relative to the back/forth direction is fixed to the base table 22. The ball screw 31 is driven to rotate the rotating plate 26. This way, the cutting-in angle of the circular blade 21 with respect to the adhesive tape roll A is adjusted and fixed by the bolt 26a at a predetermined suitable angle. After that, the base table 22 is moved parallel to the axis of the adhesive tape roll A, and the middle slide table 23b is forwarded by using the grip 34. Further, the position of the upper slide table 23c relative to the back/forth direction is adjusted so that the edge of the circular blade 21 is close to a predetermined cutting position of the body of the adhesive tape roll A. The upper slide table 23c is then clamped to the rotating plate 26 by the clamp lever 33. Finally, the cylinder 35 is operated to move the middle slide table 23b, the rotating plate 26, and the upper slide table 23c all together. The circular blade 21 pressed against the body of the adhesive tape roll A is rotated by the rotation of the adhesive tape roll A, thereby cutting in rounds the adhesive tape roll A. The forwarding of the cylinder 35 is automatically stopped by the limit switch 36 at the position where the cutting is completed.

To perform cutting for the second time and after, the middle slide table 23b, the rotating plate 26, and the upper slide table 23c are retracted all together with the cylinder 35. Then, the base table 22 is moved parallel to the axis, and the middle slide table 23b is forwarded with the grip 34 to set the edge of the circular blade 21 at the next cutting position. Then, slicing operation similar to the above is repeated by forwarding the cylinder 35.

The above embodiment deals with a case where the adhesive tape roll is driven to rotate, and the circular blade is rotated by the rotation of the adhesive tape roll. However, the adhesive tape roll cutting apparatus of the present invention may be structured so that the circular blade is driven to rotate and the adhesive tape roll is rotated by the rotation of the circular blade.

Further, the above embodiment deals with a case where the blade shaft formed in one piece is pulled out from one of the shaft bearings, and the circular blade is mounted between the pair of the shaft bearings. However, the blade shaft may be separable in a direction parallel to its axis. In such a case, two pieces of the blade shaft are separated from each other in the direction parallel to its axis, and the circular blade is set between these pieces. Then, by combining the pieces of the blade shaft, the circular blade is mounted between the two pieces of the shaft bearing.

What is claimed is:

1. A cutting apparatus for an adhesive tape roll, essentially comprising:
a tape roll supporting device to which the adhesive tape roll is rotatably attached, the adhesive tape roll formed by rolling, on a core, wide adhesive tape having an adhesive layer formed on its one side or both sides; and
a tool post to which a circular blade is mounted by inserting a rotatable blade shaft into a center hole formed on the circular blade,
wherein at least one of the adhesive tape roll and the circular blade is driven to rotate and the tool post having the circular blade mounted thereto is forwarded towards the adhesive tape roll perpendicularly to the axis of the adhesive tape roll, thereby pressing the circular blade to a predetermined cutting position on the body of the adhesive tape roll to cut in rounds the adhesive tape roll, and
wherein the rotatable blade shaft has both ends supported by a pair of shaft bearings of the tool post, and a circular blade is mounted to the blade shaft, between the pair of shaft bearings supporting the both ends of the blade shaft.

2. The cutting apparatus according to claim 1, wherein the circular blade is mounted to the tool post to be forwarded towards the adhesive tape roll, along a center line of the tool post.

3. The cutting apparatus according to claim 1, wherein a structure for attaching the circular blade to the blade shaft between the pair of shaft bearings is such that the blade shaft is pulled out from at least one of the shaft bearings, the circular blade is set between the pair of shaft bearings while the blade shaft is pulled out from that one of the shaft bearings, and then the blade shaft having been pulled out is inserted into a center hole of the circular blade and into the shaft bearing again.

4. The cutting apparatus according to claim 2, wherein a structure for attaching the circular blade to the blade shaft between the pair of shaft bearings is such that the blade shaft is pulled out from at least one of the shaft bearings, the circular blade is set between the pair of shaft bearings while the blade shaft is pulled out from that one of the shaft bearings, and then the blade shaft having been pulled out is inserted into a center hole of the circular blade and into the shaft bearing again.
